(19) United States
(12) Patent Application Publication
(10) Pub. No.: US 2006/0155825 A1
(43) Pub. Date: Jul. 13, 2006

(54) Network device managing apparatus and method and storage medium

(75) Inventor: Minoru Torii, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/330,097

(22) Filed: Jan. 12, 2006

Related U.S. Application Data
(62) Division of application No. 09/593,767, filed on Jun. 14, 2000.

(30) Foreign Application Priority Data
Jun. 16, 1999 (JP) 11-169951

(51) Int. Cl. G06F 15/16; G06F 15/173

(52) U.S. Cl. 709/217; 709/224

(57) ABSTRACT

In a network device managing method using the SNMP protocol, a device on a network is designated as a management target, and a command for acquiring management information for the device and setting the information in a memory is generated. The management information for the device which is acquired through the network is set in the memory on the basis of the command. A set or acquired result is output/displayed as management information in a predetermined form. This method makes it possible to quickly display management information of a device linked to the network in real time.

### BACKGROUND OF THE INVENTION

1. Field of the Invention

The present invention relates to a computer network and, more particularly, to a managing apparatus and method of managing devices connected to a network, and a storage medium storing a program for causing a computer to execute the managing method.

FIG. 1 shows an arrangement in which a network board (NB) 101 for connecting a printer to a network is connected to a printer 102 having an open architecture. The NB 101 is connected to a local area network (LAN) 100 via a LAN interface such as the Ethernet Interface 10 Base-2 having a coaxial connector or the 10 Base-T having RJ-45.

A plurality of personal computers (PCs) such as PCs 103 and 104 are also connected to the LAN 100. These PCs can communicate with the NB 101 under the control of a network operating system. One of these PCs, e.g., the PC 103, can be used for network management. A local printer, such as a printer 105 connected to the PC 104, can be connected to a PC.

Furthermore, a file server 106 is connected to the LAN 100 to manage access to files stored in a network disk 107 having a large capacity (e.g., 10 gigabytes).

A print server 108 causes printers, such as connected printers 109 and the printer 105 in a remote place, to perform printing. Other peripheral devices (not shown) can also be connected to this LAN 100.

In addition, a WWW server 150 is connected to the LAN 100 so that an HTML (Hyper Text Markup Language) document created by network management software installed on the WWW server 150 can be displayed by using a WWW browser installed on the PC 103, or printer settings made on the WWW browser on the PC 103 can be transmitted to a specific printer through the network management software on the WWW server 150.

More specifically, in the network shown in FIG. 1, network software such as Novell or Unix software can be used to perform communications efficiently between various network members. It is possible to use any network software, e.g., NetWare (trademark of Novell Corp.; this will be omitted hereinafter) of Novell Corp. A detailed explanation of this software package is made in on-line documentation of the NetWare package. This can be purchased together with the NetWare package from Novell Corp.

In brief, the file server 106 functions as a file manager for receiving, storing, queuing, caching, and transmitting data files between LAN members. For example, data files formed by the PCs 103 and 104 are transmitted to the file server 106. The file server 106 arranges these data files in order and, in accordance with a command from the print server 108, transmits the arranged data files to one of the printers 109.

Each of the PCs 103 and 104 is a common PC capable of forming a data file, transmitting the formed data file to the LAN 100, receiving a file from the LAN 100, and displaying and/or processing such files. Although personal computers are shown in FIG. 1, other computers suited to executing the network software can also be included. For example, when UNIX software is used, UNIX workstations can be included. These workstations can be used together with the PCs shown in FIG. 1 under appropriate conditions.

Commonly, a LAN such as LAN 100 provides services to a relatively local user group, e.g., a user group on one floor, or dispersed across a plurality of consecutive floors, in one building. For example, when a certain user is away from other users, such as when a user is in another building or in another locale, e.g., another state, prefecture or province, a wide area network (WAN) can be constructed. The WAN is basically a group formed by connecting a plurality of LANs by high-speed digital lines such as an integrated services digital network (ISDN). Accordingly, as shown in FIG. 1, LAN 100, a LAN 110, and a LAN 120 form a WAN as they are connected via a modem/transponder 130 and backbone 140.

Each LAN includes dedicated PCs and may include a file server and a print server, as needed. As shown in FIG. 1, therefore, the LAN 110 includes PCs 111 and 112, a file server 113, a network disk 114, a print server 115, and printers 116. In contrast, the LAN 120 includes only PCs 121 and 122. Devices connected to any of these LANs 100, 110, and 120 can access functions of devices of the other LANs via the WAN connections.

A large number of standards organizations have made various attempts to provide workable methods of managing devices on networks constructing such large-scale network system. The International Standardization Organization (ISO) has provided a versatile reference framework called the Open System Interconnection (OSI) model. The OSI model of a network management protocol is called a Common Management Information Protocol (CMIP). This CMIP is a common network management protocol in Europe.

In recent years, as a network management protocol having higher commonness, a Simple Network Management Protocol (SNMP) is available as a variety of the CMIP. (“Introduction to TCP/IP Network Management: Aiming at Practical Management”, M. T. Rose/translated by Takeshi Nishida, K. K. Toppan, Aug. 20, 1992, 1st ed.)

In this SNMP network management technology, a network management system includes at least one network management station (NMS), several management objective nodes each containing an agent, and a network management protocol used by the network management station and agents to exchange management information. The user can obtain or change data on the network by communicating with agent software on a management objective node by using network management software on the NMS.

An agent is software running as a background process for each target device. When the user requests a device on the network to send management data, the management software puts object identification information in a management packet or frame and sends it to the target agent. The agent interprets this object identification information, extracts data corresponding to the object identification information, and returns the data by assembling it in a packet to the user. To extract the data, a corresponding process is called in some cases.

Each agent holds data concerning its own state in the form of a database. This database is called a Management Information Base (MIB). The MIB has a tree data structure, and all nodes are uniquely numbered. This node identifier is called an object identifier.

This MIB structure is called a Structure of Management Information (SMI) and is defined by RFC1155 Structure and Identification of Management Information for TCP/IP-based Internets.

The SNMP will be briefly described below. A PC (to be referred to as a “manager” hereinafter), in which network management utility software is operating, and a management objective network device (to be referred to as an “agent” hereinafter), in which an SNMP agent is operating, communicate with each other by using the SNMP. This SNMP has five types of commands written as Get-request, Get-next-request, Get-response, Set-request, and Trap.

Get-request and Get-next-request are commands which are sent from the manager to the agent to acquire the value of an MIB object of the agent. Upon receiving these commands, the agent sends the Get-response command to the manager to inform the manager of the MIB value.

Set-request is a command which is sent from the manager to the agent to set the value of the MIB object of the agent. Upon receiving this command, the agent sends the Get-response command to the manager to inform the manager of the set result.

Trap is a command which is sent from the agent to the manager to inform the manager of a change in the state of the agent.

In a well-known system, an SNMP agent operates on the network board (NB) 101 connected to the PC and printer 102, and network management software serving as an SNMP manager operates on the PC. With the recent proliferation of the Internet, a system has been developed that makes network management software operate on a server, instead of making dedicated network management software operate on each client PC, and that also uses the WEB as a user interface.

The operation of a general WWW system and the operation of an SNMP management program based on the WWW system will be briefly described next with reference to FIG. 2.

A WWW server program 1051 operates on a PC 150. Many WWW page data described by using HTML are stored in a disk in the PC 150.

A WWW browser program 1031 operating on a PC 103 requests the WWW server program 1051 operating on the PC 150 to send a page designated by a user in order to display the page.

In response to the request from the WWW browser program 1031, the WWW server program 1051 returns the designated page data. The WWW browser program 1031 analyzes the acquired page data and displays the page in accordance with the description.

If a request having passed through the CGI (Common Gateway Interface) is contained in the page acquisition request from the WWW browser program 1031, the WWW server program 1051 activates an external script or program by a predetermined method based on the CGI, receives page data for a response to the request from the WWW browser program 1031, and returns it to the WWW browser program 1031.

A case where an external program activated by the CGI is a network management program as in the present invention will be described next.

A network management program 1052 activated by the CGI under the control of the WWW server program 1051 acquires management data from a device, e.g., the printer 102, which is connected to the network by using the SNMP. The network management program 1052 creates a page described in HTML on the basis of the acquired management data, and returns the page to the WWW server program 1051.

An application for managing devices by the SNMP/MIB uses a WWW browser program. Such application uses a template file constituted by unique keywords and an HTML description to implement a user interface on the WWW browser program.

According to the prior art described above, network management program is activated every time a request is received from a user (Web browser). Assume that the server is not holding link destination information of a window currently displayed by the browser, which is likely to be requested by the user. In this case, if information between the links is requested by the user, the server acquires the information upon communicating with the corresponding device again. That is, a long processing time is required to display the information.

In addition, even if the server is holding link destination information, since information in the database is updated at a timing different from that of a request from the user, the link destination information loses its real-time property.

### SUMMARY OF THE INVENTION

In order to achieve the above object, a network device managing apparatus and method according to the present invention have at least the following arrangements.

There is provided a network device managing apparatus using an SNMP protocol, comprising generating means for specifying a device on a network as a management target and generating a command for acquiring management information for the device and setting the information in a memory, setting means for setting, on the basis of the command, management information of the device which is acquired through the network in the memory, and output means for outputting/displaying the set or acquired management information of the device in a predetermined form.

In the network device managing apparatus, the management information is preferably information in an MIB form.

In the network device managing apparatus, the command preferably contains an HTML format for defining the predetermined form, and a management information item of the device.

In the network device managing apparatus, the output means preferably displays the set or acquired result in an HTML format.

In the network device managing apparatus, if there is an URL liked to the management information, the setting means preferably further sets or acquires linked management information.

In the network device managing apparatus, the output means preferably displays a result of management information set or acquired in accordance with the URL.

In addition, there is provided a network device managing method using an SNMP protocol, comprising the generating step of specifying a device on a network as a management target and generating a command for acquiring management information for the device and setting the information in a memory, the setting step of setting, on the basis of the command, management information of the device which is acquired through the network in the memory, and the output step of outputting/displaying the set or acquired management information of the device in a predetermined form.

In the network device managing method, the management information is preferably information in an MIB form.

In the network device managing method, the command preferably contains an HTML format for defining the predetermined form, and a management information item of the device.

In the network device managing method, the output step preferably comprises displaying the set or acquired result in an HTML format.

In the network device managing method, if there is an URL liked to the management information, the setting step preferably further comprises setting or acquiring linked management information.

In the network device managing method, the output step preferably comprises displaying a result of management information set or acquired in accordance with the URL.

Furthermore, there is provided a computer-readable storage medium storing a program for managing network devices using an SNMP protocol, the program comprising a code for the generating step of specifying a device on a network as a management target and generating a command for acquiring management information for the device and setting the information in a memory, a code for the setting step of setting, on the basis of the command, management information of the device which is acquired through the network in the memory, and a code for the output step of outputting/displaying the set or acquired management information of the device in a predetermined form.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an arrangement in which a printer having a network board is connected to a network;

FIG. 2 is a view for explaining an outline of the operation of an SNMP management program;

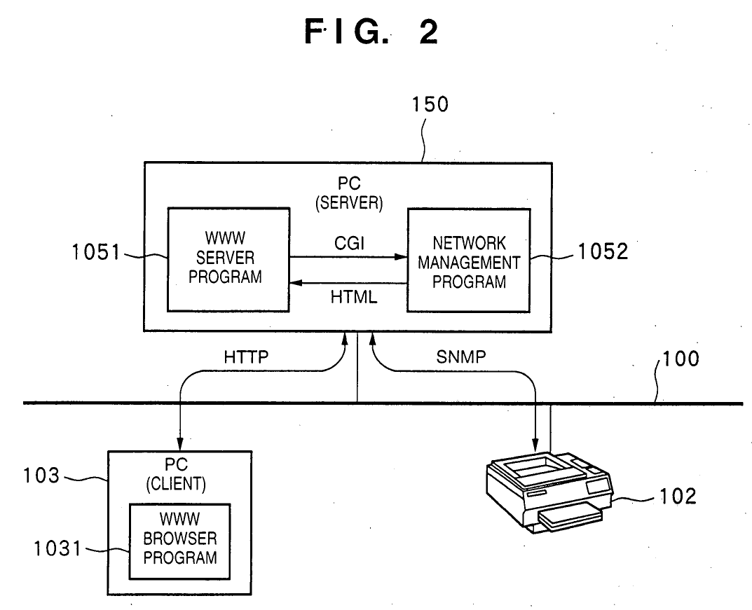

FIG. 3 is a block diagram showing the arrangement of a PC on which network management software operates;

FIG. 4 is a block diagram showing the module configuration of the network management software according to the present invention;

FIG. 5 is a view showing the arrangement of a template file according to the present invention;

FIG. 6 is a view showing a device list window;

FIG. 7 is a view showing an example of a display window for showing the details of a device;

FIG. 8 is a block diagram showing the file configuration of the network management software;

FIG. 9 is a flow chart for explaining a procedure for acquiring management information of a network device and displaying the result;

FIG. 10 is a flow chart for explaining a procedure for a linked URL; and

FIG. 11 is a flow chart for explaining a procedure for displaying URL information.

### DETAILED DESCRIPTION OF THE PREFERRED EMBODIMENTS

Preferred embodiments of the present invention will be now be described in detail in accordance with the accompanying drawings.

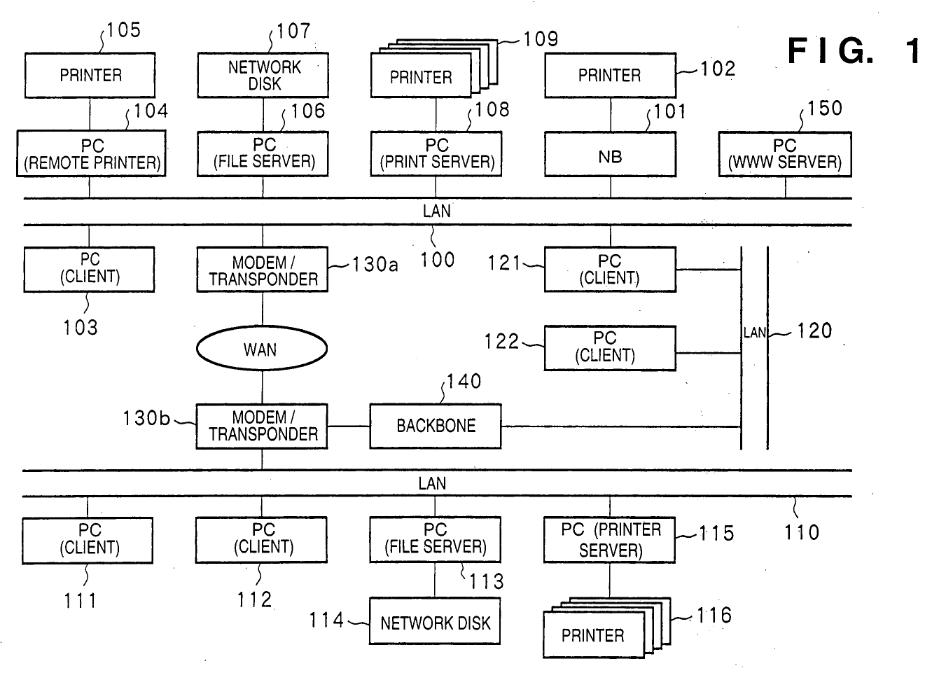

Network management software (network management program) of the present invention is constituted by a PC 103 on which a Web browser like the one shown in FIG. 1 can operate, a WWW server 150, and a printer 102 connected to a network board 101 having the function of the SNMP/MIB.

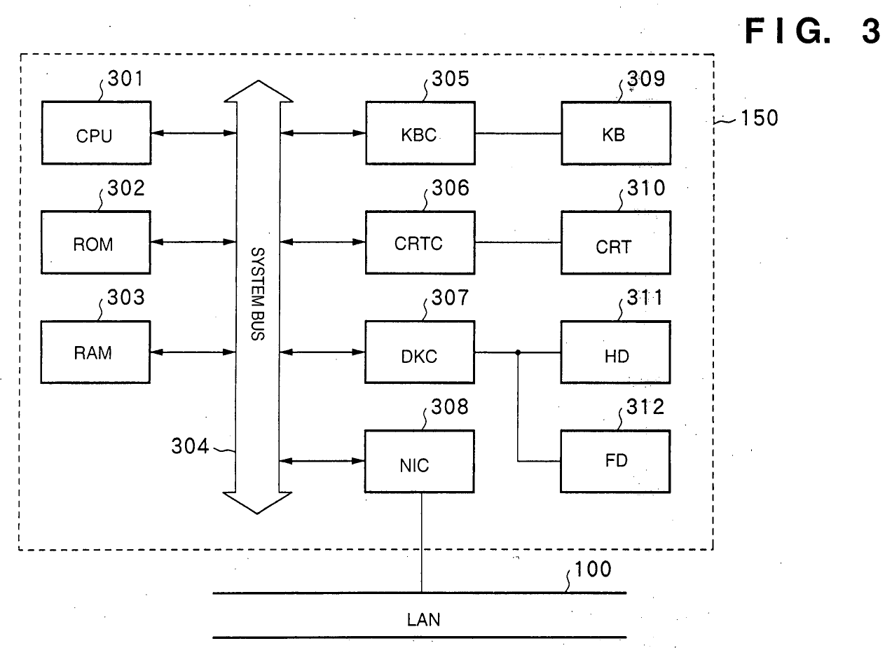

FIG. 3 shows the arrangement of a PC on which this network management software can operate. Referring to FIG. 3, the WWW server 150 is a PC on which the network management software operates, and equivalent to the WWW server 150 shown in FIG. 1. The PC 150 includes a CPU 301 which executes a network management program stored in a ROM 302 or in a hard disk (HD) 311 or supplied from a floppy disk (FD) 312, and comprehensively controls individual devices connected to a system bus 304.

A RAM 303 functions as a main memory and work area for the CPU 301. A keyboard controller (KBC) 305 controls input instructions from a keyboard (KB) 309, a pointing device (not shown), and the like. A CRT controller (CRTC) 306 controls the display of a CRT display (CRT) 310. A disk controller (DKC) 307 controls access to the hard disk (HD) 311 and floppy disk (FD) 312 storing a boot program, various applications, edit files, user files, the network management program, and the like. A network interface card (NIC) 308 bidirectionally exchanges data with agents or network devices via a LAN 100.

The hard disk (HD) 311 stores a program of the network management software according to the present invention, which is the main part of operation in the explanation to be described later. In the explanation described later, the main hardware part of the execution is the CPU 301 unless otherwise specified. On the other hand, the main software part of control is the network management software stored in the hard disk (HD) 311. In this embodiment, Windows NT (Microsoft Corp.) and IIS (Internet Information Server) are assumed as an OS and WWW server, respectively. However, an OS and WWW server are not the only possible implementations.

The network management program according to the present invention can also be supplied as it is stored in a storage medium such as a floppy disk or a CD-ROM. In this case, the program is read out from the storage medium by the floppy disk controller (FD) 312 shown in FIG. 3 or a CD-ROM driver (not shown) and installed in the hard disk (HD) 311.

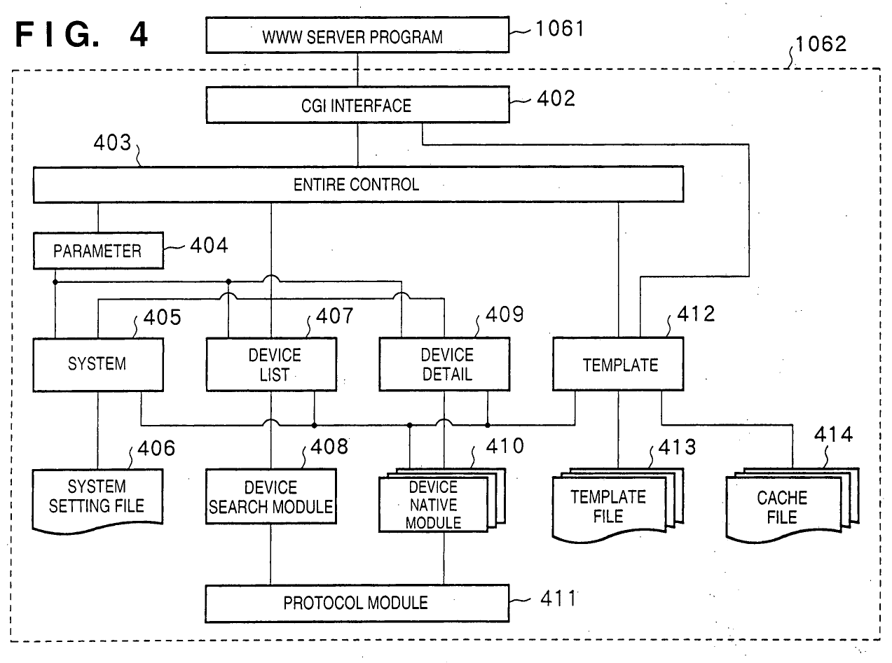

FIG. 4 shows the module configuration of the network management software according to the present invention.

Network management software 1062 according to the present invention is stored in the hard disk 311 shown in FIG. 3 and executed by the CPU 301. During the execution, the CPU 301 uses the RAM 303 as a work area.

Referring to FIG. 4, the network management software 1062 is activated by a WWW server program 1061 to exchange CGI parameters and HTML documents through a CGI interface 402.

A system control module 403 registers CGI parameters in a parameter module 404 (to be described later), and then transfers control to a system module 405, device list module 407, or device detail module 409 (to be described later) in accordance with a command parameter in the CGI parameters. If there is an error in the CGI parameters, the system control module 403 may create an HTML document indicating the presence of the error in the CGI parameters through a template module 412.

The parameter module 404 stores/manages the CGI parameters, registered by the system control module 403, in a tabular form. Other modules can acquire desired parameters from the CGI interface 402, as needed.

The system module 405 controls display/setting of system parameters (e.g., automatic update interval for HTML documents) that define the operation of the network management software 1062, and creates associated HTML documents. The system module 405 acquires a command parameter from the parameter module 404. If the contents of the command parameter indicate a system parameter display request, the system module 405 reads out necessary information from a system setting file 406, and creates an HTML document for system parameter display through the template module 412. If the contents of the acquired command parameter indicate a system parameter setting request, the system module 405 writes the informed system parameter in the system setting file 406, and creates an HTML document to be displayed after setting through the template module 412. Although not shown, system parameters stored in the system setting file 406 can be read out by the respective modules constituting the network management software 1062, as needed.

The device list module 407 creates an HTML document indicating a list of devices (device list) searched out by a device search module 408 (to be described later). The device list module 407 also controls processing for a device list display option or the like.

The device search module 408 searches for a device connected to the network.

The device detail module 409 performs control to display/set detailed information about a specific device designated by a CGI parameter, and also creates an associated HTML document. The device detail module 409 uses a device native module 410 (to be described later) corresponding to the designated device to acquire/set detailed information about the designated device.

The device native module 410 is prepared for each device (a printer, network interface, or the like) to be managed by the network management software. In display operation, the device native module 410 acquires necessary information from a device, and sets the acquired information in the template module 412. In setting operation, the device native module 410 converts a set value informed by a CGI parameter into a value that can be interpreted by a device, and transmits the value to the device.

A protocol module 411 performs control on various protocols required for the network management software to communicate with devices, e.g., handling of the MIB (Management Information Base), transmission/reception of SNMP (Simple Network Management Protocol) packets, and control on a transport protocol.

A template module 412 creates an HTML document as an output result of the network management software on the basis of a template file 413 stored in the hard disk 311 in FIG. 3.

The template module 412 opens a template file designated by a CGI parameter, the system control module 403, the system module 405, the device list module 407, or the device detail module 409, and analyzes the contents of the template file. The template module 412 then creates an HTML document by replacing the template variables contained in the template file with values set by the system control module 403, system module 405, device list module 407, device detail module 409, or device native module 410, and transmits the document to a WWW server program via the CGI interface 402. The values of the template variables used to create the HTML document or the created HTML document file can be stored as a cache file 414 in the hard disk 311 in FIG. 3 to shorten the processing time required to create the second and subsequent HTML documents on the basis of the same template file.

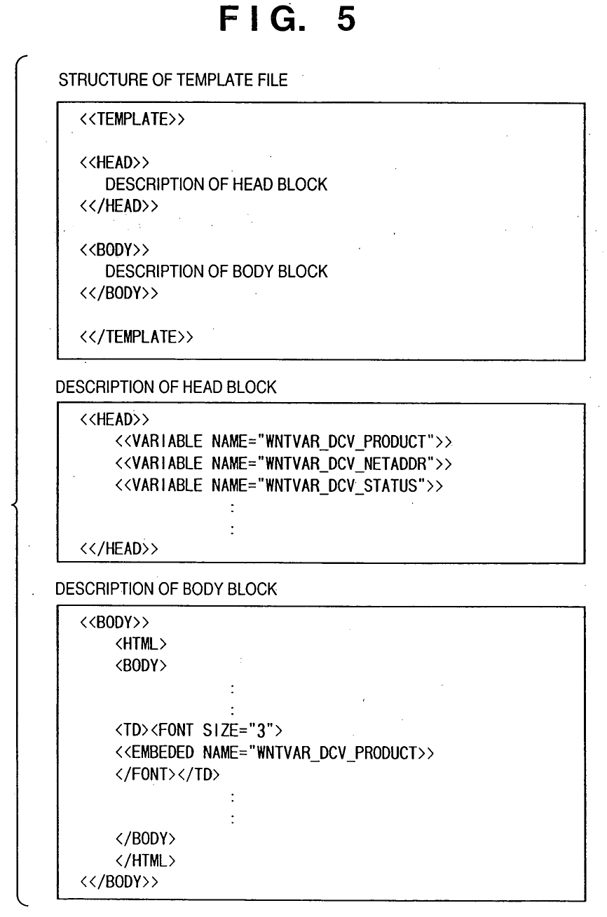

FIG. 5 shows the format of a template file according to the present invention.

The contents of a template file used in network management software 1062, which are shown in FIG. 5, are described between the <<TEMPLATE>> tag and the <</TEMPLATE>> tag. The description between these tags is constituted by two blocks, the HEAD block described between <<HEAD>> tag and the <</HEAD>> tag and the BODY block described between the <<BODY>> tag and the <</BODY>> tag.

In the HEAD block, the <<VARIABLE>> tags in which pieces of information to be acquired from a device are described as variables are mainly described. The BODY block is constituted by an output HTML description, the <<EMBED>> tag in which values acquired from the device are embedded, and the like.

As is obvious from FIG. 5, network management software 1062 may acquire a product name indicated by WNTVAR_DCV_PRODUCT by parsing the HEAD block. Upon acquiring this information, network management software 1062 acquires information from the device by the SNMP/MIB. Thereafter, network management software 1062 replaces the <<EMBED>> tag having the variable “WNTVAR_DCV_PRODUCT” with the information acquired from the device by parsing the BODY block. By performing parsing operation like that described above with respect to all the variables, an HTML file to be output can be obtained.

The following is a list of tags used in a template file and their functions:

| Tag | Function |
|---|---|
| TEMPLATE | template description |
| HEAD | header description |
| BODY | body description |
| LINK | associated template description |
| VARIABLE | declaration of template variable |
| INCLUDE | inclusion of template file |
| SET | setting of value of variable |
| EMBED | embedding of variable value |
| ISVALID | evaluation of validity of variable value |
| EVAL | comparison between variable values |
| LOOP | repetitive description |
| COMMENT | comment description |
| LINKURL | description of URL to be linked |

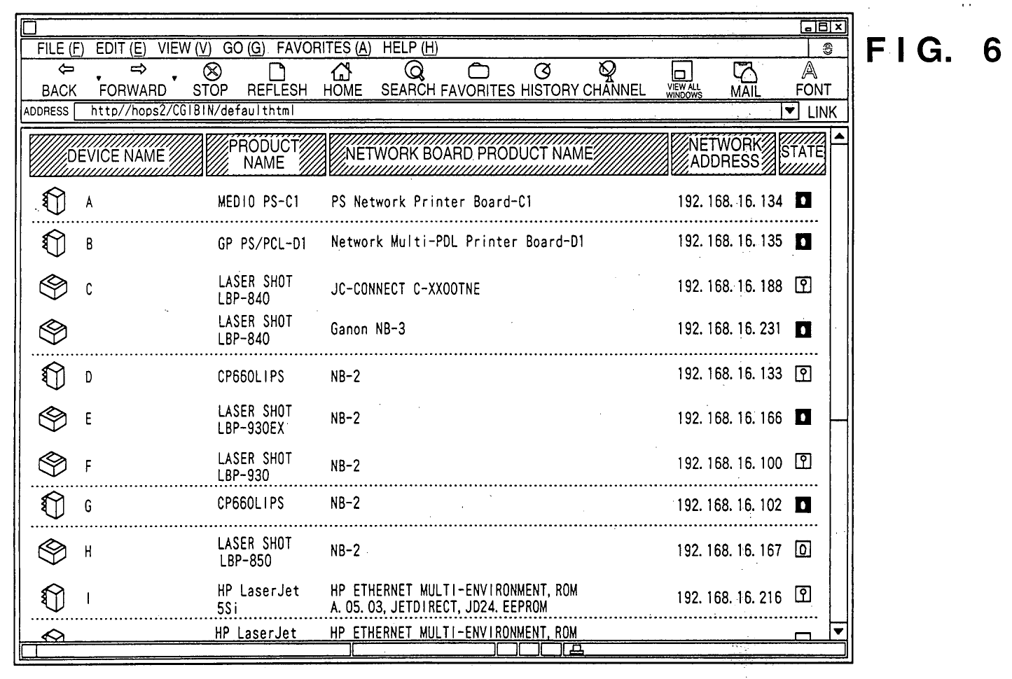

FIG. 6 shows a window called a device list. When the user designates a URL indicating this window, network management software 1062 is activated through the CGI. Network management software 1062 searches for devices connected to the network, and displays, on the browser, the following information about the devices detected by the search:
DEVICE TYPE
DEVICE NAME
PRODUCT NAME
PRODUCT NAME OF NETWORK BOARD
NETWORK ADDRESS
STATE OF DEVICE

The type of device indicates whether the device is a commonly-used printer or a composite machine having a copy function as well, and is displayed as an icon. A device name is a name given to each device by the user. When the user clicks this device name, network management software 1062 is activated again to display the detailed information about the device. This operation will be described in detail later. The state of the device is indicated by changing the icon in accordance with the importance of a current error.

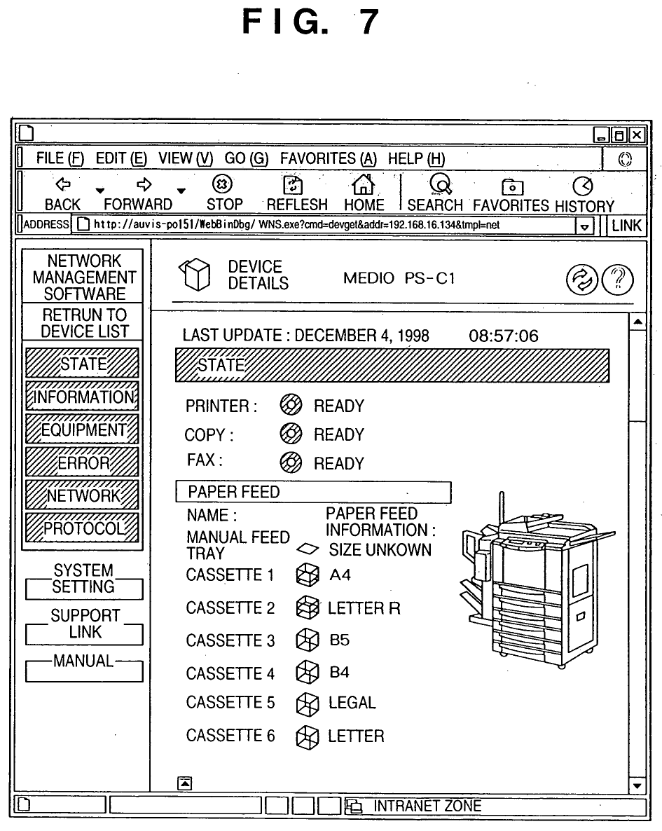

When the user clicks a device name in the device list, an IP address is transferred to network management software 1062, and detailed information about the clicked device is acquired on the basis of this information. The detailed information is then displayed on the browser. The display information includes a state, equipment information, device information, network board information, and protocol information. These pieces of information are displayed in a plurality of windows. FIG. 7 is an example of a display window. FIG. 7 shows the details of a device.

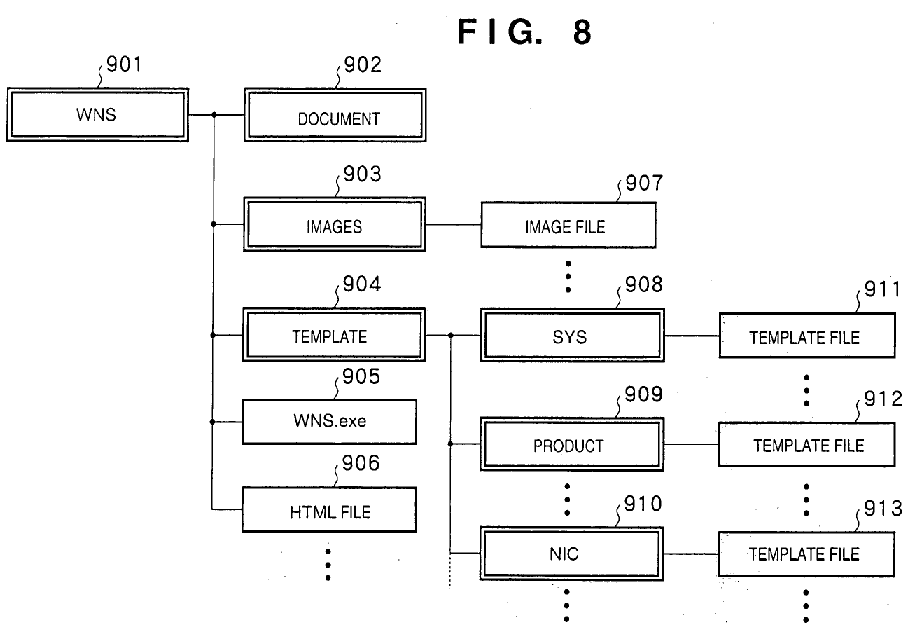

FIG. 8 shows the file configuration of network management software 1062. Each double-frame box indicates a directory; and each single-frame, a file. Reference numeral 901 denotes a root directory of network management software 1062 as a CGI program. The following directories are subordinate to this root directory:
Document
Images
Template

In addition, WNS.exe (an execution file) and various HTML files are present.

In a Document directory 902, information acquired from a device is temporarily stored as a cache file. In an Images directory 903, various image files used for the display of information are stored. In a directory 904, a template file is stored. Three types of directories are subordinate to the directory 904, as follows.

In a sys directory 908, a template file for the display of information independent of devices, e.g., a device list and error relations, is stored. In product directories 909, template files associated with information unique to products are stored. The number of product directories is equal to the number of product types. Information stored in each of these directories includes a state, equipment information, and device information shown in FIG. 7. In NIC directories 910, information unique to network boards is stored. Information stored in these NIC directories equal in number to repairs to the network boards includes network information and protocol information.

If the same template file can be created for a plurality of products or network boards, directories need not always be prepared in a number equal to the number of types of products or network boards.

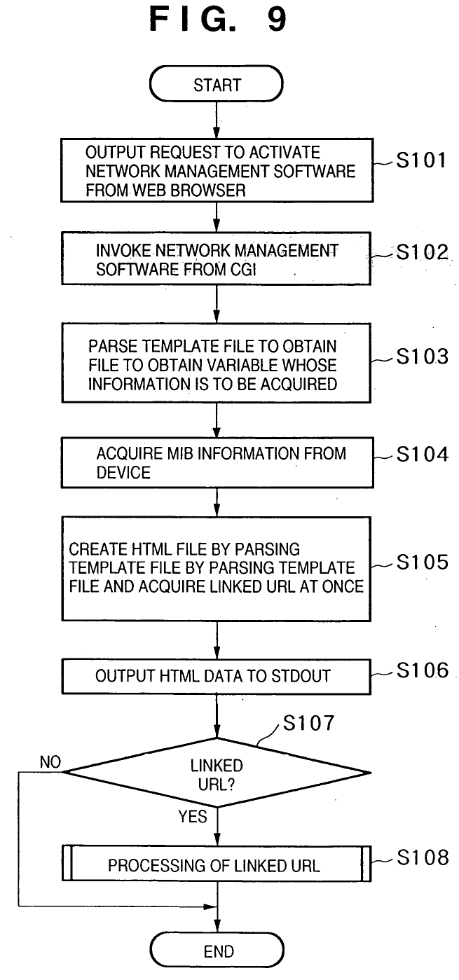

FIG. 9 is a flow chart showing a procedure for making network management software 1062, activated on the PC 150, acquire MIB information of a device and display the information on the browser on the PC 103 in a case wherein network management software 1062 on the PC 150 on which the WWW server operates is activated from the WWW browser on the PC 103 in FIG. 1 to manage the printer 102 (in which the SNMP agent is installed).

In step S101 in the flow chart of FIG. 9, network management software 1062 is invoked by sending, over the Get command, a command identifier for indicating whether to acquire or set device information from the Web browser and a template identifier for identifying a template.

In step S102, network management software 1062 is activated through the CGI. In step S103, activated network management software 1062 opens the template designated by the command identifier and template identifier sent over the Get command in step S101, and parses a list of information to be acquired from the device from the HEAD portion of the template file. As shown in FIG. 5, the template file is constituted by two structures, namely the HEAD portion between <<HEAD>> and <</HEAD>> and the BODY portion between <<BODY>> and <</BODY>>. In the <<HEAD>> portion, useful information to be recognized by network management software 1062 in advance is stored. For example, a list of variables representing information to be acquired from the device indicated by <<VARIABLE NAME= . . . >> is defined.

The <<BODY>> portion is made up of a description in an HTML form which is to be displayed on the Web browser and template variables replaced with the information acquired from the device.

In step S104, MIB information is actually acquired from the device in accordance with the list of variables acquired in step S103, i.e., the list of variables indicated by the <<VARIABLE NAME= . . . >> tags.

In step S105, the <<BODY>> portion is parsed by using the MIB information acquired in the step S104. More specifically, an HTML file to be output is created by replacing the template variable <<EMBED . . . >> with the value acquired from the device. When the <<BODY>> portion is parsed, linked URL information indicated by the <<LINKURL>> tag is stored. For example, the menu on the page showing the details of the device in FIG. 7 is linked to URLs indicating error information, network information, and protocol information. When the user presses this button, network management software 1062 is activated again to acquire error information, network information, or protocol information from the device and display the information on the Web browser.

As the URL indicating the network information, <<LINKURL=WNS.exe?cmd=devget&addr=192.168.16.132&tmpl=network>> is described in the template file. Information is therefore acquired from the device by using a template file named as network.wtf.

In step S106, the transmission file created in step S105 is output to STDOUT. With this operation, the information is displayed on the Web browser on the PC 103.

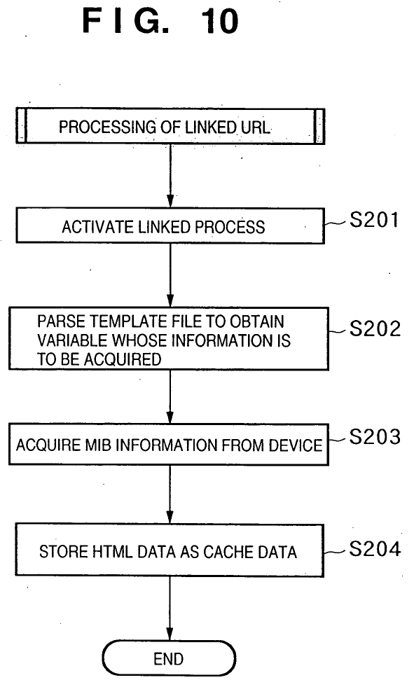

In step S107, it is checked whether there is any linked URL and the <<LINKURL>> tag is parsed. If there is a linked URL, the flow advances to step S108 to process the linked URL. This processing will be described in detail with reference to the flow chart of FIG. 10. If there is no linked URL, the processing is terminated.

A method of acquiring information from a device on the basis of linked URL information will be described with reference to the flow chart of FIG. 10.

In step S201 in the flow chart of FIG. 10, WNS.exe is activated in another process on the basis of the information acquired by parsing the <<LINKURL>> tag in step S105 in FIG. 9. For example, since the network information indicated by the device detail menu in FIG. 7 is described as <<LINKURL=WNS.exe?cmd=devget&addr=192.168.132&tmpl=network>>, MIB information is acquired from the device whose IP address is 192.168.132 by using the network.wtf template file.

In step S202, a list of information to be acquired from the device is obtained by parsing the template file designated by the <<LINKURL= . . . >> tag. As in step S103 of FIG. 9, this information is defined by a list of variables representing information to be acquired from the device indicated by <<VARIABLE NAME= . . . >>.

In step S203, MIB information is acquired from the device on the basis of the list of information to be acquired from the device which is obtained in step S202.

In step S204, the template variable <<EMBED . . . >> is replaced with the value acquired from the device by using the MIB information acquired in step S203, thereby creating an HTML file to be output. This file is stored as cache data in the Document directory in FIG. 8 without outputting to STDOUT.

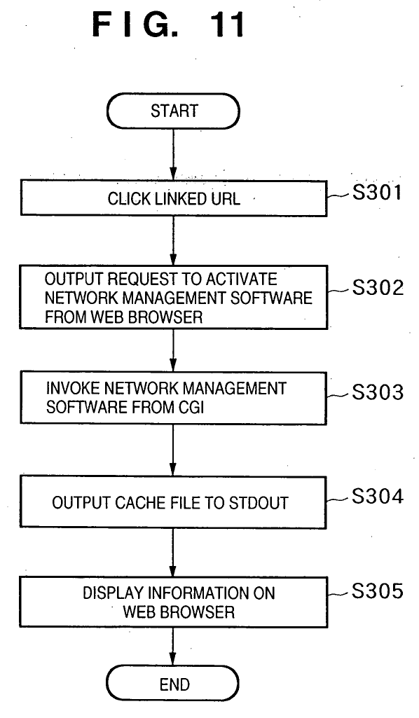

Operation to be performed when the user is to be display linked URL information will be described with reference to the flow chart of FIG. 11.

In step S301 in the flow chart of FIG. 11, the user clicks the linked URL.

In step S302, the Web browser sends, over the Get command, a command identifier for indicating whether to acquire or set device information and a template identifier for identifying a template to be used, thereby invoking network management software 1062.

In step S303, network management software 1062 is activated through the CGI.

In step S304, cache data using the flow chart of FIG. 10 is output to STDOUT.

In step S305, the cache data is output to the Web browser, and the information of the linked URL is displayed.

The information of the URL associated with the linked device is acquired by another process that has activated network management software 1062, and designated variables are replaced with acquired values. The resultant data is stored as cache data. This makes it possible to provide the cache data to the user without communicating with a device in response to every request from the user.

The information acquired in this manner is based on the Get.command sent from the user, the latest data on the network can be provided in real time.

Note that the present invention may be applied to either a system constituted by a plurality of devices (e.g., a host computer, an interface device, a reader, a printer, and the like), or an apparatus consisting of a single device (e.g., a copying machine, a facsimile apparatus, or the like).

The objects of the present invention are also achieved by supplying a storage medium (or a recording medium), which records a program code of a software program that can realize the functions of the above-mentioned embodiments to the system or apparatus, and reading out and executing the program code stored in the storage medium by a computer (or a CPU or MPU) of the system or apparatus. In this case, the program code itself read out from the storage medium realizes the functions of the above-mentioned embodiments, and the storage medium which stores the program code constitutes the present invention. The functions of the above-mentioned embodiments may be realized not only by executing the readout program code by the computer but also by some or all of actual processing operations executed by an OS (operating system) running on the computer on the basis of an instruction of the program code.

Furthermore, the functions of the above-mentioned embodiments may be realized by some or all of actual processing operations executed by a CPU or the like arranged in a function extension board or a function extension unit, which is inserted in or connected to the computer, after the program code read out from the storage medium is written in a memory of the extension board or unit.

When the present invention is applied to the above storage medium, program codes corresponding to the flow charts (shown in FIGS. 9, 10 and/or 11) described above are stored.

As has been described above, according to the network device managing apparatus and method of the present invention, the information of a linked URL is acquired by another process and stored as cache data. This makes it possible to quickly provide device information to a user without communicating a device in response to every request from the user.

In addition, since the linked information is obtained immediately before a user issues a request to acquire link destination information, the information can be provided as information with an excellent real-time property to the user.

As many apparently widely different embodiments of the present invention can be made without departing from the spirit and scope thereof, it is to be understood that the invention is not limited to the specific embodiments thereof except as defined n the claims.

1-13. (canceled)

14. A network device managing apparatus for managing a network device based on processing first display information of the device and second display information linked from the first display information, said apparatus comprising:
recognizing means for recognizing link information embedded in the first display information;
obtaining means for obtaining an instruction for displaying information based on the second display information;
acquiring means for acquiring, from the network device, management information of the device related to the second display information in accordance with the link information recognized by said recognizing means before said obtaining means obtains the instruction to display the information based on the second display information; and
means for providing output information corresponding to the second display information including the acquired management information, and for transferring the output information to a predetermined communication link.

15. A device according to claim 14, wherein the first display information is described in a web page.

16. A device according to claim 14, wherein said acquiring means acquires management information in accordance with template data which describes management information to be acquired from the network device.

17. A network device managing method for managing a network device based on processing first display information of the device and second display information linked from the first display information, said method comprising the steps of:
recognizing link information embedded in the first display information;
obtaining instruction to be used for displaying information based on the second display information;
acquiring management information of the device related to the second display information in accordance with the link information recognized in said recognizing step before the instruction to display the information based on the second display information is obtained in said obtaining step; and
providing output information corresponding to the second display information including the acquired management information and transferring the output information to a predetermined communication link.

18. A device according to claim 17, wherein the first display information is described in a web page.

19. A device according to claim 17, wherein said acquiring step includes acquiring management information in accordance with template data which describes management information to be acquired from the network device.

20. A network device managing apparatus for managing a network device based on processing first display information of the device and second display information linked from the first display information, said apparatus comprising:
a recognizing unit adapted to recognize link information embedded in the first display information;
an obtaining unit adapted to obtain an instruction for displaying information based on the second display information;
an acquiring unit adapted to acquire, from the network device, management information of the device related to the second display information in accordance with the link information recognized by said recognizing unit before said obtaining unit obtains the instruction to display the information based on the second display information; and
a unit adapted to provide output information corresponding to the second display information including the acquired management information, and to transfer the output information to a predetermined communication link.
